(19) United States
(12) Patent Application Publication
(10) Pub. No.: US 2013/0289828 A1
(43) Pub. Date: Oct. 31, 2013

(54) OCCUPANT PROTECTION SYSTEM

(71) Applicant: DENSO CORPORATION, Kariya-city (JP)

(72) Inventor: Hiroyoshi Takeuchi, Kariya-city (JP)

(73) Assignee: Denso Corporation, Kariya-city (JP)

(21) Appl. No.: 13/870,247

(22) Filed: Apr. 25, 2013

(30) Foreign Application Priority Data
Apr. 27, 2012 (JP) 2012-103543

(51) Int. Cl. B60R 21/0132

(52) U.S. Cl. CPC B60R 21/0132
USPC 701/45

(57) ABSTRACT

In an occupant protection system, a controller includes first and second comparison portions, and an activation control portion. The first comparison portion compares a first detection result from a first acceleration detection portion with a first positive threshold value and a first negative threshold value and outputs a first comparison signal when the first detection result is larger than the first positive threshold value or smaller than the first negative threshold value. The second comparison portion compares a second detection result from a second acceleration detection portion with a second positive threshold value and a second negative threshold value and outputs a second comparison signal when the second detection result is larger than the second positive threshold value or smaller than the second negative threshold value. The activation control portion activates one of side occupant protection devices based on positive or negative of the first and second detection results.

### CROSS REFERENCE TO RELATED APPLICATION

This application is based on Japanese Patent Application No. 2012-103543 filed on Apr. 27, 2012, the disclosure of which is incorporated herein by reference.

### TECHNICAL FIELD

The present disclosure relates to an occupant protection system.

### BACKGROUND

There is known an occupant protection system that detects the vehicle acceleration, determines an occurrence of collision, and activates an occupant protection device such as an air bag when the collision is determined. Recent occupant protection systems are provided with a side occupant protection device. The side occupant protection device restricts an occupant from colliding with the vehicle side if the vehicle is collided from the side or rotates due to offset frontal collision. In the event of offset frontal collision, the rear part of the vehicle may rotate to the left (clockwise) or to the right (counterclockwise) around the frontal part. In such a case, the side occupant protection device is activated to restrict the occupant from colliding with the seat side.

For example, a vehicle collision determination apparatus described in JP 2009-96297 A is provided with an acceleration detection portion that is disposed at the vehicle side and detects acceleration in a vehicle lateral direction. The side occupant protection device is activated when the acceleration in the vehicle longitudinal direction exceeds a threshold value and the acceleration in the vehicle lateral direction exceeds a threshold value.

### SUMMARY

If a vehicle encounters offset frontal collision, the vehicle side may be deformed to protrude outward (e.g., see FIG. 10) or inward (e.g., see FIG. 11). In such a case, if a detection result from the acceleration detection portion at the vehicle side exceeds the threshold value even though there is no acceleration in the vehicle lateral direction enough to activate the side occupant protection device, the side occupant protection device may be activated unexpectedly.

It is an object of the present disclosure to provide an occupant protection system capable of reducing incorrect determination on vehicle rotation and accurately controlling activation of a side occupant protection device.

According to an aspect of the present disclosure, an occupant protection system includes a first acceleration detection portion, a second acceleration detection portion, a first side occupant protection device, a second side occupant protection device, and a controller. The first acceleration detection portion is disposed at a first side of a vehicle and detects acceleration with respect to a vehicle lateral direction. The second acceleration detection portion is disposed at a position distant from the first acceleration detection portion with respect to a vehicle lateral direction in the vehicle and detects acceleration with respect to the vehicle lateral direction. The first side occupant protection device is disposed adjacent to the first side of the vehicle, and the second side occupant protection device is disposed adjacent to a second side of the vehicle. The controller controls the side occupant protection devices based on detection results from the first acceleration detection portion and the second acceleration detection portion. The controller includes a first comparison portion, a second comparison portion, and an activation control portion. The first comparison portion compares a value of a first detection result obtained based on a detection result of the first acceleration detection portion with a first positive threshold value and a first negative threshold value, which are provided for the first acceleration detection portion. The first comparison portion outputs a first comparison signal when the value of the first detection result is larger than the first positive threshold value or is smaller than the first negative threshold value. The second comparison portion compares a value of a second detection result obtained based on a detection result of the second acceleration detection portion with a second positive threshold value and a second negative threshold value provided for the second acceleration detection portion. The second comparison portion outputs a second comparison signal when the value of the second detection result is larger than the second positive threshold value or is smaller than the second negative threshold value. The activation control portion activates one of the side occupant protection devices based on whether the value of each of the first detection result and the second detection result being positive or negative, when the activation control portion receives the first comparison signal and the second comparison signal.

In the above configuration, two threshold values having different polarities are provided for each of the two acceleration sensors that detect the acceleration with respect to the vehicle lateral direction. The controller detects rotation of the vehicle and determines activation of the side occupant protection devices based on the detection results from the two acceleration sensors. Therefore, incorrect determination due to expanding deformation of the vehicle at an event of an offset frontal collision reduces. Further, the occupant protection devices are accurately activated.

### BRIEF DESCRIPTION OF THE DRAWINGS

The above and other objects, features and advantages of the present disclosure will become more apparent from the following detailed description made with reference to the accompanying drawings, in which like parts are designated by like reference numbers and in which:

FIG. 1 is a conceptual diagram illustrating a configuration of an occupant protection system according to a first embodiment;

FIG. 2 is a conceptual diagram illustrating a configuration of an occupant protection device ECU according to the first embodiment;

FIG. 3 is a conceptual diagram illustrating a configuration of the occupant protection system and a flow of activation determination according to the first embodiment;

FIG. 4 is a conceptual diagram illustrating a configuration of the occupant protection system and a flow of activation determination according to the first embodiment;

FIG. 5 is a conceptual diagram illustrating threshold values for the occupant protection system according to the first embodiment;

FIG. 6 is a conceptual diagram illustrating a configuration of an occupant protection device ECU according to a second embodiment;

FIG. 7 is a conceptual diagram illustrating a configuration of an occupant protection system and a flow of activation determination according to the second embodiment;

FIG. 8 is a conceptual diagram illustrating a configuration of an occupant protection system according to a third embodiment;

FIG. 9 is a conceptual diagram illustrating a configuration of an occupant protection device ECU according to the third embodiment;

FIG. 10 is a conceptual diagram illustrating an example of deformation due to collision on vehicle sides; and

FIG. 11 is a conceptual diagram illustrating an example of deformation due to collision on vehicle sides.

### DETAILED DESCRIPTION

Embodiments of the present disclosure will be described in further detail. Hereinafter, like parts are designated by like reference numbers throughout the embodiments.

### First Embodiment

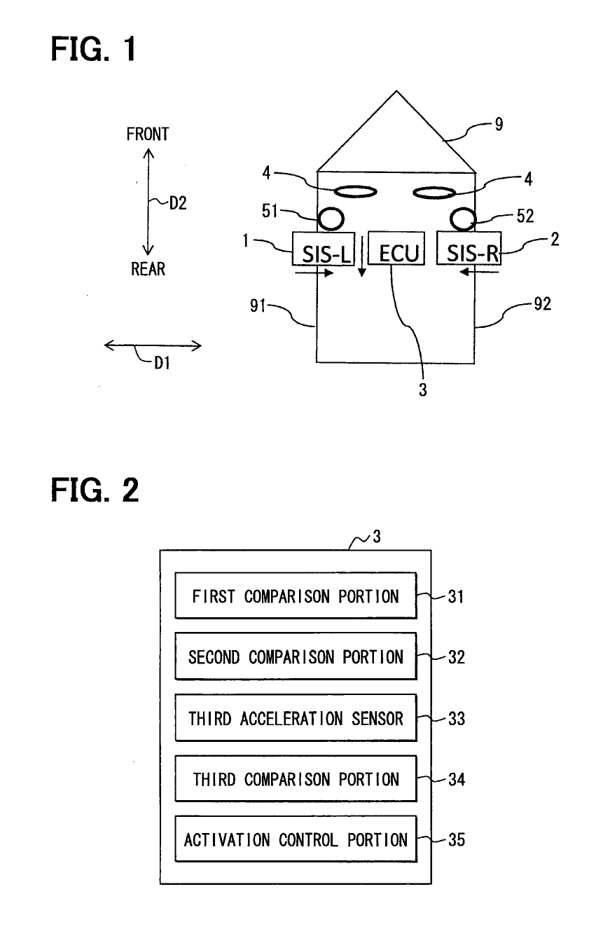

Referring to FIG. 1, the occupant protection system according to the first embodiment includes a first acceleration sensor 1, a second acceleration sensor 2, an occupant protection device ECU 3, a front occupant protection device 4, and first and second side occupant protection devices 51 and 52.

The first acceleration sensor 1 is a side impact sensor (SIS) that detects acceleration with respect to a vehicle lateral direction D1. The first acceleration sensor 1 corresponds to a first acceleration detection portion. The first acceleration sensor 1 is disposed at one side (e.g., first side) 91 of a vehicle 9 toward the front. The first acceleration sensor 1 transmits a detection result to the occupant protection device ECU 3. The concept of “acceleration” in the embodiments includes a value (calculated value) corresponding to the acceleration. The polarity of the first acceleration sensor 1 is configured to be positive toward the inside of the vehicle (to the right of FIG. 1 as illustrated by an arrow).

The second acceleration sensor 2 is a side impact sensor (SIS) that detects acceleration with respect to the vehicle lateral direction D1. The second acceleration sensor 2 corresponds to a second acceleration detection portion. The second acceleration sensor 2 is disposed at the other side (e.g., second side) 92 of the vehicle 9 toward the front. The first acceleration sensor 1 and the second acceleration sensor 2 are provided distantly from each other with respect to the vehicle lateral direction D1. The second acceleration sensor 2 transmits a detection result to the occupant protection device ECU 3. The polarity of the second acceleration sensor 2 is configured to be positive toward the inside of the vehicle (to the left of FIG. 1 as illustrated by an arrow).

The occupant protection device ECU 3, which corresponds to a controller, is an electronic control unit and is disposed at a middle position with respect to the vehicle lateral direction D1 toward the front. As illustrated in FIG. 2, the occupant protection device ECU 3 includes a first comparison portion 31, a second comparison portion 32, a third acceleration sensor 33, a third comparison portion 34, and an activation control portion 35.

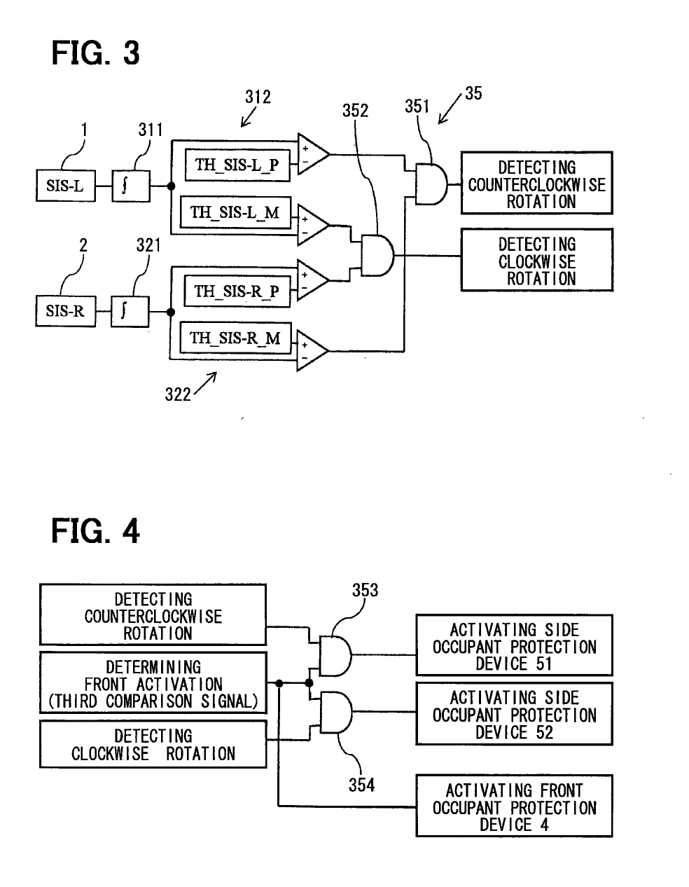

The first comparison portion 31 is an arithmetic unit. The first comparison portion 31 compares a first detection result calculated based on a detection result from the first acceleration sensor 1 with a first positive threshold value and a first negative threshold value predetermined for the first acceleration sensor 1. As illustrated in FIG. 3, the first comparison portion 31 includes an integration operation portion 311 to integrate the detection result transmitted from the first acceleration sensor 1 and a comparison operation portion 312.

The first detection result is acquired by integrating a detection result transmitted from the first acceleration sensor 1 at a predetermined integration interval. The integration operation portion 311 calculates the first detection result at the predetermined integration interval. The integration interval is configured based on a detection interval of the acceleration sensor. The first positive threshold value and the first negative threshold value are provided in the comparison operation portion 312. The comparison operation portion 312 outputs a first comparison signal to the activation control portion 35 when the first detection result is larger than the first positive threshold value (TH_SIS-L_P) or when the first detection result is smaller than the first negative threshold value (TH_SIS-L_M). A comparator can be used as the comparison operation portion 312.

Configured similarly to the first comparison portion 31, the second comparison portion 32 includes an integration operation portion 321 and a comparison operation portion 322. The integration operation portion 321 integrates a detection result transmitted from the second acceleration sensor 2. A second detection result is acquired by integrating the detection result transmitted from the second acceleration sensor 2 at a predetermined integration interval.

The comparison operation portion 322 compares the second detection result calculated based on a detection result from the second acceleration sensor 2 with a second positive threshold value (TH_SIS-R_P) and a second negative threshold value (TH_SIS-R_M) predetermined for the second acceleration sensor 2. The second positive threshold value and the second negative threshold value are provided in the comparison operation portion 322. The comparison operation portion 322 outputs a second comparison signal to the activation control portion 35 when the second detection result is larger than the second positive threshold value or when the second detection result is smaller than the second negative threshold value.

The third acceleration sensor 33 detects acceleration with respect to a vehicle longitudinal direction D2. The third acceleration sensor 33 transmits a detection result to the third comparison portion 34. Configured similarly to the first comparison portion 31, the third comparison portion 34 compares a third detection result calculated based on a detection result from the third acceleration sensor 33 with a third (positive) threshold value predetermined for the second acceleration sensor 2. For example, the polarity of the third acceleration sensor 33 is configured to be positive toward the rear of the vehicle. Namely, the third detection result indicates a positive value for acceleration in a vehicle rearward direction.

The third detection result is acquired by integrating a detection result transmitted from the third acceleration sensor 33 at a predetermined integration interval. The third threshold value is positive and is predetermined in the third comparison portion 34. The third comparison portion 34 transmits a third comparison signal to the activation control portion 35 when the third detection result exceeds (i.e., is greater than) the third threshold value. In a case where the polarity of the third acceleration sensor 33 is configured to be positive toward the front of the vehicle, the third threshold value is set to be negative. The third comparison signal is output when the third detection result falls below (i.e., is smaller than) the third threshold value. Accordingly, when the third detection result passes the third threshold value, such that it exceeds or falls below the third threshold value, the third comparison signal is outputted.

The activation control portion 35 controls activation of the front occupant protection device 4 and the side occupant protection devices 51 and 52. The activation control portion 35 is connected to the first comparison portion 31, the second comparison portion 32, the third comparison portion 34, the front occupant protection device 4, and the side occupant protection devices 51 and 52.

When the activation control portion 35 receives the third comparison signal, the activation control portion 35 outputs an activation instruction to the front occupant protection device 4 to activate the front occupant protection device 4. When the activation control portion 35 receives the third comparison signal as well as the first and second comparison signals, the activation control portion 35 activates the front occupant protection device 4 and one of the side occupant protection devices 51 and 52 based on the polarity of the first and second detection results, that is, based on whether the values of the first and second detection results being positive or negative.

The activation control portion 35 receives the first comparison signal and the polarity information of the first detection result from the first comparison portion 31. Similarly, the activation control portion 35 receives the second comparison signal and the polarity information of the second detection result from the second comparison portion 32.

In the present embodiment, the first acceleration sensor 1 and the second acceleration sensor 2 are configured to have the positive polarity for acceleration toward the inside of the vehicle. Suppose a case where the vehicle 9 rotates due to offset frontal collision. If the vehicle 9 rotates counterclockwise (e.g., in FIG. 1), the first detection result is positive and the second detection result is negative. If the vehicle 9 rotates clockwise (e.g., in FIG. 1), the first detection result is negative and the second detection result is positive. In other words, if the vehicle 9 rotates counterclockwise, the first detection result indicates a positive value and the second detection result indicates a negative value. Also, if the vehicle 9 rotates clockwise, the first detection result indicates a negative value and the second detection result indicates a positive value.

As described above, the activation control portion 35 specifies the rotation direction of the vehicle 9 and activates one of the side occupant protection devices 51 and 52 based on the polarities predetermined for the first acceleration sensor 1 and the second acceleration sensor 2 and the polarities indicated in the first and second detection results. According to the present embodiment, the activation control portion 35 allows activation of the side occupant protection devices 51 and 52 when the first and second detection results indicate different polarities. The activation control portion 35 activates the side occupant protection device 51 or 52 corresponding to the acceleration sensor whose detection result indicates a positive value.

Specifically, as illustrated in FIGS. 3 and 4, the activation control portion 35 includes AND circuits 351 through 354. The activation control portion 35 assumes the rotation counterclockwise when the AND circuit 351 receives the first comparison signal from the positive side and the second comparison signal from the negative side. The activation control portion 35 assumes the rotation clockwise when the AND circuit 352 receives the first comparison signal from the negative side and the second comparison signal from the positive side. The activation control portion 35 activates the side occupant protection device 51 when the AND circuit 353 receives a rotation detection signal indicating the counterclockwise rotation and the third comparison signal. The activation control portion 35 activates the side occupant protection device 52 when the AND circuit 354 receives a rotation detection signal indicating the clockwise rotation and the third comparison signal.

The front occupant protection device 4 includes an air bag, such as a front air bag and a knee air bag, provided toward the front of the front seat, such as a driver's seat or a passenger seat. Each of the side occupant protection devices 51 and 52 includes an air bag, such as a side air bag and a curtain air bag, disposed in a vehicle side area, such as a seat side, a pillar, or roof lining, corresponding to the side of the front seat. The side occupant protection device 51 is disposed adjacent to the first side 91 of the vehicle 9. The side occupant protection device 52 is disposed adjacent to the second side 92 of the vehicle 9.

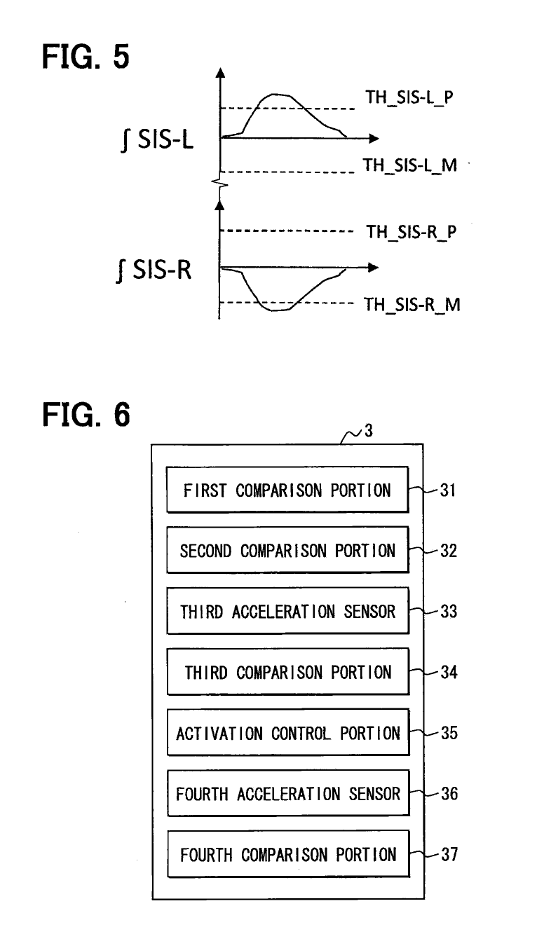

In the event of offset collision, for example, when the third comparison signal is output, the first detection result is greater than the first positive threshold value and the second detection result is smaller than the second negative threshold value, as shown in FIG. 5, the activation control portion 35 activates the side occupant protection device 51 on the left where the first acceleration sensor 1 that has output the first detection result indicating a positive value (exceeding the positive threshold value) is disposed.

In the occupant protection system according to the present embodiment, two threshold values having different polarities (positive and negative) are provided for each of the two acceleration sensors 1 and 2 that detect the acceleration with respect to the vehicle lateral direction D1. The rotation direction of the vehicle and the necessity of activation of the side occupant protection device 51 and 52, that is, whether to activate the side occupant protection device 51 or 52 are determined based on the detection results of the first and second acceleration sensors 1 and 2. Therefore, the occupant protection system can reduce incorrect determination due to expanding deformation of the vehicle 9 in the event of the offset frontal collision. As such, the occupant protection system can accurately control activation of the occupant protection device. Since both the positive threshold value and the negative threshold value are provided for each acceleration sensor, each acceleration sensor can detect rotations in both directions.

According to the present embodiment, the activation control portion 53 activates the side occupant protection devices 51 and 52 on condition of input of the third comparison signal for activating the front occupant protection device 4. Namely, one of the side occupant protection devices 51 and 52 is activated in response to the rotation due to a collision that requires activation of the front occupant protection device 4. A collision that requires activation of the front occupant protection device 4 is likely to cause expanding deformation of side members or the like of the vehicle 9, resulting in incorrect determination for the activation of the side occupant protection devices 51 and 52. In the present embodiment, however, as described above, incorrect determination is reduced, and the activation is accurately controlled.

In the present embodiment, the acceleration sensors 1 and 2 provided on both sides 91 and 92 of the vehicle 9 for side collisions are used. Therefore, the determination accuracy is improved without requiring an additional acceleration sensor. Each of the acceleration sensors 1 and 2 is provided with the positive and negative threshold values and is therefore used directly without changing polarities thereof. The acceleration sensors 1 and 2 are originally designed to detect side collisions and are configured to be positive toward the inside of the vehicle, that is, to output the detection result with a positive value for the acceleration from the outside to the inside of the vehicle 9. In the present embodiment, therefore, increase of labor hours due to changes in the sensor layout or polarity settings is reduced. Further, since the rotation of the vehicle 9 is determined when both detection results from the acceleration sensors 1 and 2 indicate polarities different from each other, the determination reliability improves.

### Second Embodiment

An occupant protection system according to a second embodiment is different from that of the first embodiment in that the occupant protection device ECU 3 further includes a fourth acceleration sensor 36 and a fourth comparison portion 37. Hereinafter, a different configuration will be mainly described.

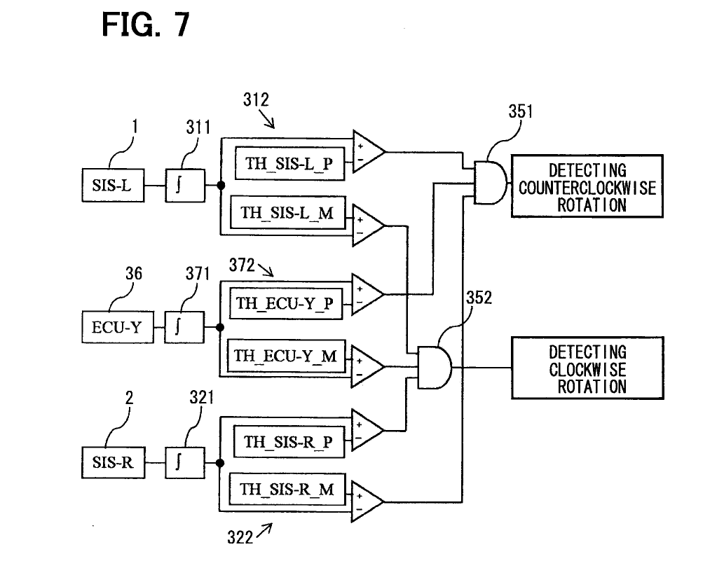

As illustrated in FIGS. 6 and 7, the occupant protection device ECU 3 according to the second embodiment includes the fourth acceleration sensor 36, which corresponds to a fourth acceleration detection portion, and the fourth comparison portion 37 in addition to the configuration of the first embodiment. The fourth acceleration sensor 36 detects acceleration with respect to the vehicle lateral direction D1 and has the positive polarity toward the second acceleration sensor 2 (right side).

The fourth comparison portion 37 is configured similarly to the first comparison portion 31. The fourth comparison portion 37 includes an integration operation portion 371 and a comparison operation portion 372. The integration operation portion 371 integrates a detection result from the fourth acceleration sensor 36. The comparison operation portion 372 compares a fourth detection result from the integration operation portion 371 with a fourth positive threshold value (TH_ECU-Y_P) and a fourth negative threshold value (TH_ECU-Y_M). The comparison operation portion 372 outputs a fourth comparison signal to the activation control portion 35 when the fourth detection result is larger than the fourth positive threshold value or when the fourth detection result is smaller than the fourth negative threshold value.

When the activation control portion 35 receives the fourth comparison signal, the first comparison signal and the second comparison signal, the activation control portion 35 activates one of the side occupant protection devices 51 and 52 based on the polarity (positive value or negative value) of the detection results. According to the second embodiment, similarly to the first embodiment as illustrated in FIG. 4, the side occupant protection devices 51 and 52 are activated when the activation control portion 35 receives the third comparison signal. Therefore, when the activation control portion 35 receives the first through fourth comparison signals, the activation control portion 35 activates one of the side occupant protection devices 51 and 52 as well as the front occupant protection device 4.

Specifically, the activation control portion 35 determines the rotation counterclockwise when the AND circuit 351 receives the first comparison signal being on a positive side, the fourth comparison signal being on a positive side, and the second comparison signal being on a negative side. The activation control portion 35 determines the rotation clockwise when the AND circuit 352 receives the first comparison signal being on a negative side, the fourth comparison signal being on a negative side, and the second comparison signal being on a positive side. Thus, the activation control portion 35 activates the front occupant protection device 4 and one of the side occupant protection devices 51 and 52.

In the occupant protection system according to the second embodiment, two threshold values having different polarities are provided for each of three acceleration sensors 1, 2, and 36 that detect the acceleration with respect to the vehicle lateral direction D1. The rotation of the vehicle 9 and whether to activate the side occupant protection device 51 or 52 are determined based on the detection results of the acceleration sensors 1, 2, and 36. Therefore, the occupant protection system can more accurately control activation of the occupant protection device. The occupant protection device ECU 3 may be provided with an acceleration sensor for detecting acceleration with respect to the vehicle longitudinal direction D2 and an acceleration sensor for detecting acceleration with respect to the vehicle lateral direction D1. In such a case, the acceleration sensors can be used. Therefore, it is less likely that the manufacturing costs will increase.

### Third Embodiment

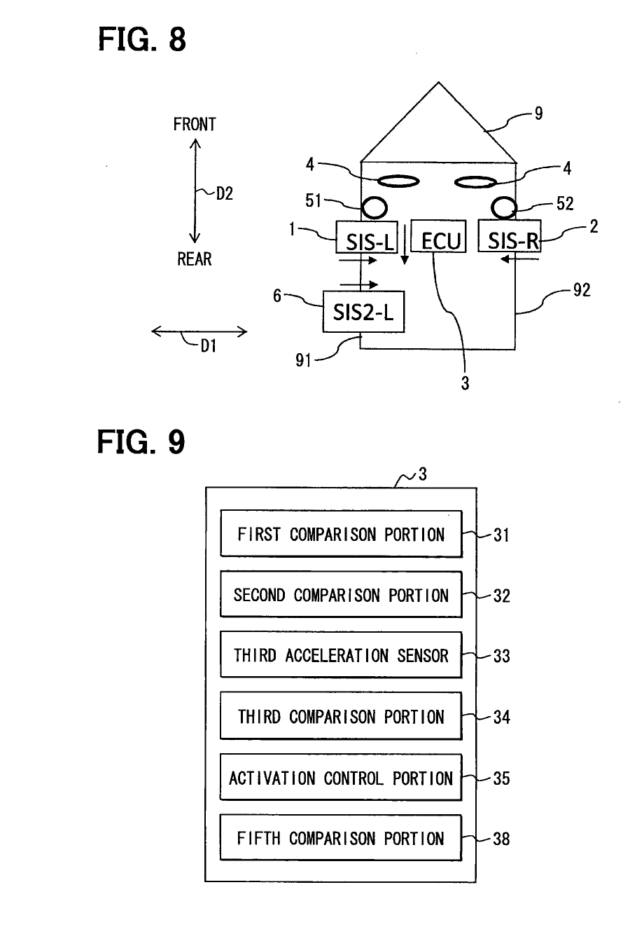

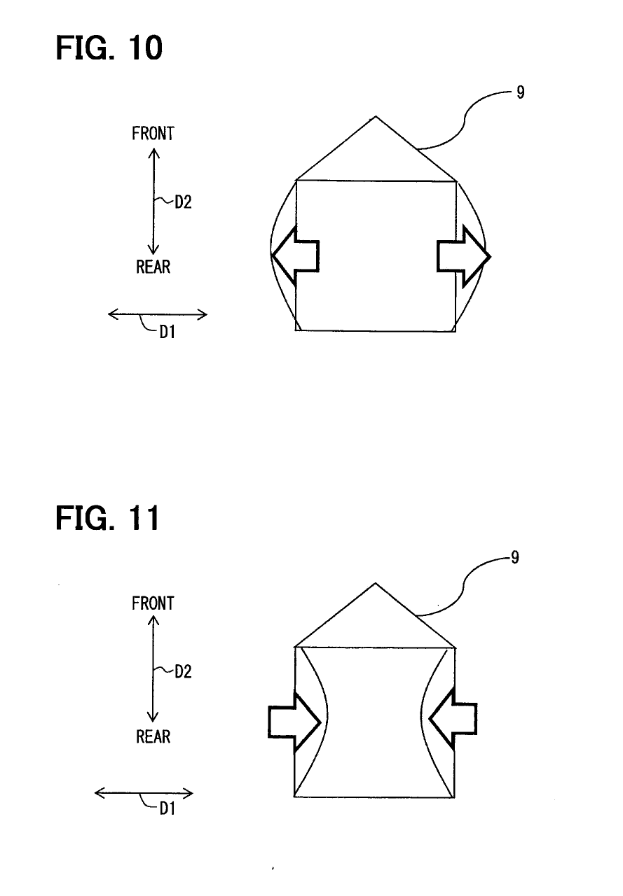

An occupant protection system according to a third embodiment is different from that of the first embodiment in that a fifth acceleration sensor 6 and a fifth comparison portion 38 are further provided as illustrated in FIGS. 8 and 9. Hereinafter, a different configuration will be mainly described.

The fifth acceleration sensor 6 is a side impact sensor (SIS) disposed on a rear side of the first acceleration sensor 1. The fifth acceleration sensor 6 corresponds to a fifth acceleration detection portion. The fifth acceleration sensor 6 detects acceleration with respect to the vehicle lateral direction D1. Namely, in the third embodiment, multiple acceleration sensors are arranged in the vehicle longitudinal direction D2 on the vehicle side, such as on the first side 91.

The occupant protection device ECU 3 according to the third embodiment includes the fifth comparison portion 38 in addition to the configuration of the first embodiment. Similar to the fourth comparison portion 37 of the second embodiment, the fifth comparison portion 38 includes an integration operation portion and a comparison operation portion. The integration operation portion integrates a detection result from the fifth acceleration sensor 6. The comparison operation portion compares a fifth detection result from the integration operation portion with a fifth positive threshold value (TH_SIS2-L_P) and a fifth negative threshold value (TH_SIS2-L_M). The comparison operation portion 382 outputs a fifth comparison signal to the activation control portion 35 when the fifth detection result is larger than the fifth positive threshold value or when the fifth detection result is smaller than the fifth negative threshold value. The fifth acceleration sensor 6 is arranged nearer to the vehicle rear than the first acceleration sensor 1. Therefore, an absolute value of the fifth threshold value is set larger than absolute values of the first and second threshold values.

When receiving the fifth comparison signal, the first comparison signal, and the second comparison signal, the activation control portion 35 activates one of the side occupant protection devices 51 and 52 based on the polarity (positive value or negative value) of the detection results. The configuration of the activation control portion 35 is similar to that of the second embodiment except that the fourth comparison signal of the second embodiment is replaced with the fifth comparison signal, and a description thereof is omitted for simplicity.

In the present embodiment, an absolute value of the fifth threshold value is larger than the first and second threshold values. This matches the rotation characteristic that a speed with respect to the vehicle lateral direction D1 increases at a position distant from the rotation center (vehicle front). Therefore, the incorrect determination on the rotation is further reduced, and activation of the side occupant protection devices 51 and 52 is more accurately controlled.

<Others>

The present disclosure is not limited to the above-mentioned embodiments. For example, the polarities of the acceleration sensor may be configured in other ways. In the first embodiment, the polarities of the acceleration sensors 1 and 2 may be configured to be positive in the same direction. In such a case, the rotation can be determined to be counterclockwise or clockwise when the detection results of both the first and second acceleration sensors 1 and 2 indicate the same polarity (positive value or negative value). The rotation direction can be determined based on the direction of the polarity predetermined. In the first embodiment, the polarities of the acceleration sensors 1 and 2 may be configured to be positive toward the outside of the vehicle. In this case, the rotation can be determined when the detection results of both the first and second acceleration sensors 1 and 2 indicate different polarities. These configurations can also improve accuracy of controlling the activation of the side occupant protection devices 51 and 52.

In the second embodiment, the activation control portion 35 may be configured to determine the rotation and the activation based on the detection results of the first acceleration sensor 1 and the fourth acceleration sensor 36. In this case, the activation control portion 35 detects the counterclockwise rotation and determines that the activation is necessary when the AND circuit receives the first comparison signal being on a positive side and the fourth comparison signal being on a positive side. The activation control portion 35 detects the clockwise rotation and determines that the activation is necessary when the AND circuit receives the first comparison signal being on a negative side and the fourth comparison signal being on a negative side.

Similarly, the activation control portion 35 may be configured to determine the rotation and the activation based on the detection results of the second acceleration sensor 2 and the fourth acceleration sensor 36. In this case, the activation control portion 35 detects the rotation and determines the activation when it receives the second and fourth comparison signals indicating different polarities.

The occupant protection system uses at least two acceleration sensors. At least one of the acceleration sensors may be disposed at a vehicle side, and the other may be disposed at a position distant from the vehicle side with respect to the vehicle lateral direction D1. The rotation and the activation may be determined based on the detection results of the second acceleration sensor 2 and the fifth acceleration sensor 6. In a case where a vehicle has an acceleration sensor, such as a satellite sensor capable of detecting acceleration with respect to the vehicle lateral direction D1, on a rear side of the occupant protection device ECU 3, the detection results of this acceleration sensor may be also used to determine the rotation direction and the activation of the side occupant protection devices 51 and 52. These configurations can also accurately control activation of the side occupant protection devices 51 and 52.

It is not always necessary that the activation control portion 35 requires the input of the third comparison signal as a condition to activate the side occupant protection devices 51 and 52. In this case, the AND circuits 353 and 354 are unneeded. The above-mentioned embodiments may be combined appropriately.

In FIGS. 3 and 4, the third comparison signal may be input to the AND circuits 351 and 352. In this case, when one of the AND circuits 351 and 352 receives all of the first through third comparison signals, a corresponding one of the side occupant protection devices 51 and 52 may be activated.

The value (e.g., a first detection result) used to determine the collision or the rotation may be acquired by integrating twice an output value (i.e., the amount of movement) from the acceleration sensor. Moreover, the value (e.g., a first detection result) used to determine the collision or the rotation may be acquired by using a low-pass filter having a low cut-off frequency corresponding to the amount of change in the speed

While only the selected exemplary embodiments have been chosen to illustrate the present disclosure, it will be apparent to those skilled in the art from this disclosure that various changes and modifications can be made therein without departing from the scope of the disclosure as defined in the appended claims. Furthermore, the foregoing description of the exemplary embodiments according to the present disclosure is provided for illustration only, and not for the purpose of limiting the disclosure as defined by the appended claims and their equivalents.

What is claimed is:

1. An occupant protection system comprising:
a first acceleration detection portion being disposed at a first side of a vehicle, the first acceleration detection portion detecting acceleration with respect to a vehicle lateral direction;
a second acceleration detection portion being disposed at a position distant from the first acceleration detection portion with respect to the vehicle lateral direction in the vehicle, the second acceleration detection portion detecting acceleration with respect to the vehicle lateral direction;
a first side occupant protection device being disposed adjacent to the first side of the vehicle;
a second side occupant protection device being disposed adjacent to a second side of the vehicle; and
a controller including:
a first comparison portion that compares a value of a first detection result obtained based on a detection result of the first acceleration detection portion with a first positive threshold value and a first negative threshold value, which are provided for the first acceleration detection portion, and outputs a first comparison signal when the value of the first detection result is larger than the first positive threshold value or is smaller than the first negative threshold value;
a second comparison portion that compares a value of a second detection result obtained based on a detection result of the second acceleration detection portion with a second positive threshold value and a second negative threshold value, which are provided for the second acceleration detection portion, and outputs a second comparison signal when the value of the second detection result is larger than the second positive threshold value or is smaller than the second negative threshold value; and
an activation control portion that activates one of the first side occupant protection device and the second side occupant protection device based on whether the value of each of the first detection result and the second detection result being positive or negative, when the activation control portion receives the first comparison signal and the second comparison signal.

2. The occupant protection system according to claim 1, comprising:
a third acceleration detection portion detecting acceleration with respect to a vehicle longitudinal direction; and
a front occupant protection device being disposed in front of a seat of the vehicle, wherein
the controller includes a third comparison portion that compares a value of a third detection result obtained based on a detection result of the third acceleration detection portion with a third threshold value, and outputs a third comparison signal when the value of the third detection result passes the third threshold value,
the activation control portion activates the front occupant protection device when the activation control portion receives the third comparison signal, and
the activation control portion also activates one of the first side occupant protection device and the second side occupant protection device, when the activation control portion receives the first and second comparison signals as well as third comparison signal.

3. The occupant protection system according to claim 1, wherein
the second acceleration detection portion is disposed at the second side of the vehicle.

4. The occupant protection system according to claim 3, wherein
each of the first acceleration detection portion and the second acceleration detection portion is configured to detect acceleration from outside to inside of the vehicle as positive, and
when the activation control portion receives the first comparison signal and the second comparison signal, one of the first detection result and the second detection result indicates a positive value, and the other of the first detection result and the second detection result indicates a negative value, the activation control portion activates one of the first side occupant protection device and the second side occupant protection device that is associated with the detection result indicating the positive value.

5. The occupant protection system according to claim 3, wherein
the controller includes a fourth acceleration detection portion and a fourth comparison portion,
the fourth acceleration detection portion is disposed at a middle of the vehicle with respect to the vehicle lateral direction, and detects acceleration with respect to the vehicle lateral direction,
the fourth comparison portion compares a value of a fourth detection result obtained based on a detection result from the fourth acceleration detection portion with a fourth positive threshold value and a fourth negative threshold value, which are provided for the fourth acceleration detection portion, and outputs a fourth comparison signal when the value of the fourth detection result is larger than the fourth positive threshold value or is smaller than the fourth negative threshold value, and
the activation control portion activates one of the first side occupant protection device and the second side occupant protection device based on whether the value of each of the fourth detection result, the first detection result and the second detection result being positive or negative, when the activation control portion receives the first and second comparison signals as well as the fourth comparison signal.

6. The occupant protection system according to claim 1, comprising:
a fifth acceleration detection portion being disposed at a position distant from the first acceleration detection portion toward a vehicle rear, the fifth acceleration detection portion detecting acceleration with respect to the vehicle lateral direction, wherein
the controller includes a fifth comparison portion that compares a value of a fifth detection result obtained based on a detection result of the fifth acceleration detection portion with a fifth positive threshold value and a fifth negative threshold value, which are provided for the fifth acceleration detection portion, and outputs a fifth comparison signal when the value of the fifth detection result is larger than the fifth positive threshold value or is smaller than the fifth negative threshold value,
the fifth positive threshold value is larger than the first positive threshold value,
the fifth negative threshold value is smaller than the first negative threshold value, and
the activation control portion activates one of the first side occupant protection devices and the second side occupant protection device based on whether the value of each of the fifth detection result, the first detection result and the second detection result being positive or negative, when the activation control portion receives the first and second comparison signals as well as the fifth comparison signal.
